(19) United States
(12) Patent Application Publication
(10) Pub. No.: US 2020/0250685 A1
(43) Pub. Date: Aug. 6, 2020

(54) CONTRACT MANAGEMENT, COMPLIANCE AND FINANCIAL REPORTING SYSTEM AND METHOD

(71) Applicant: Reality Technology, Inc., Denver, CO (US)

(72) Inventors: Ivan Drinks, SR., Denver, CO (US); Ivan Drinks, JR., Denver, CO (US)

(21) Appl. No.: 16/783,605

(22) Filed: Feb. 6, 2020

Related U.S. Application Data
(60) Provisional application No. 62/801,733, filed on Feb. 6, 2019.

(51) Int. Cl. G06Q 30/00; G06Q 10/06; G06Q 40/00

(52) U.S. Cl. CPC G06Q 30/018; G06Q 40/12; G06Q 10/06315

(57) ABSTRACT

A contract management, compliance monitoring and financial reporting system and method are provided on a computer system, receiving inputs from multiple sources and providing outputs for effective reporting and monitoring. Contract operational and administrative processes can be adjusted as necessary for optimum performance and regulatory compliance. Financial data can also be reported under appropriate security conditions, including encryption.

### CROSS-REFERENCE TO RELATED APPLICATION

This application claims priority in U.S. Provisional Patent Application No. 62/736,869 Filed Feb. 5, 2019, which is incorporated herein by reference.

### BACKGROUND OF THE INVENTION

### 1. Field of the Invention

The present invention relates generally to a system and method for contract management, compliance monitoring and financial reporting, and in particular to an interactive, software-based system for effectively managing government and other institutional contracts.

### 2. Description of the Related Art

Systems and methods for contract administration are utilized in a wide variety of transactions among public and private contracting parties. Previously there has not been available a system and method for managing, monitoring and reporting contractual relationships with the advantages and features of the present invention. These advantages include managing multiple contracts and agreements with one resource; intuitively following procurement and payment processes commonly used by professional contracting parties; efficiently amending and renewing contracts; minimizing time and human resources committed to contract administration; interfacing multiple contracts, contracting parties and different products and services; maintaining confidentiality and trade secrets proprietary to contracting parties; enabling sharing successful contracting relationships among other parties; facilitating collaborative relationships and joint ventures; and compliance with applicable laws, regulations and contracting relationships.

Another advantage relates to generating small business participation in technology generated by government-funded research and development, e.g., integration with leading transaction and procurement systems. Moreover, the system can automate compliance reporting for timely, cost-efficient reporting. Other benefits include optimizing relations with local suppliers and local area residents and promoting the government goal of shared prosperity in the economy. The present invention provides a resource for effectively eliminating certain size-related barriers to small businesses, increasing their viability. Business spending and investment are often multiplied and leveraged throughout a business community.

Significant resources are often allocated to contractual administration and compliance activities, with corresponding costs and overhead. Costs of goods and services procured under such regulatory conditions tend to increase accordingly.

The present invention addresses these problems by providing a contract administration, compliance management and financial reporting system and method capable of handling multiple relationships among different industries. The system is scalable and usable among different industries. Moreover, international commercial activities can be managed by pre-programming the system for country-specific criteria. Efficient business operations can be achieved by utilizing computerized systems for automatically communicating with participants in the business model. Such efficiencies can accommodate scheduling goals and further increase profitability.

### BRIEF SUMMARY OF THE INVENTION

In the practice of the present invention, a system and method are provided for managing contracts in compliance with applicable laws, rules and regulations. The system and method are configured for interaction among multiple contracting parties. Moreover, the system and method are scalable and otherwise adaptable for accommodating a wide variety of contractual relations with various controlling parameters.

### BRIEF DESCRIPTION OF THE DRAWINGS

The drawings constitute a part of this specification and include exemplary embodiments of the present invention illustrating various objects and features thereof.

FIG. 1 is a schematic diagram of a post-award lifecycle showing an exemplary application of a contract management method embodying an aspect of the present invention.

FIG. 2 is a flow diagram showing a portion of the contract management, compliance monitoring and financial reporting methodology.

### DESCRIPTION OF EXEMPLARY EMBODIMENTS OR ASPECTS OF THE INVENTION

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. Said terminology will include the words specifically mentioned, derivatives thereof and words of similar meaning.

### II. Contract Administration, Clients and Financial Reporting System and Method.

In practicing an aspect of the present invention, a relationship among multiple parties is formed. For example, a purchaser or owner contracts for goods and/or services with a prime contractor, which subcontracts with additional contractors, vendors and suppliers for the deliverable goods and/or services. Depending on the nature and scope of the project, multiple contract layers may be involved.

The system of the present invention is configured for operation on computer systems for their advantages of speed, efficiency, and processing power. The system can be installed on an N-tier architecture computer or system, a local-area network (LAN) or a wide-area network (WAN). The system can also be cloud-based and operate online using various shared resources.

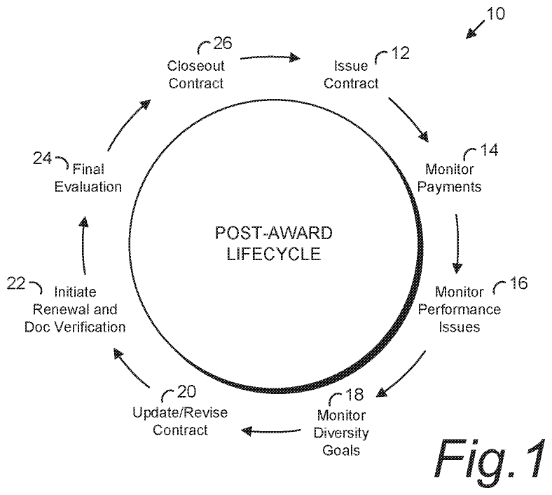

As shown in FIG. 1, an initial step is issuing a contract at 12. The contract can comprise a standalone procurement contract, an ongoing supply contract or various other contracting models. Payments are monitored at 14, and can comprise lump sum, progress payments, retainers and other payment quantifiers. Performance issues are monitored at 16. Without limitation, these can include quality control, timeliness, etc. Diversity goals are a factor in many contractual relationships and are monitored at 18. Contracting with governmental agencies typically involves significant diversity participation. The present system facilitates and expedites the necessary monitoring and reporting requirements for diversity compliance.

Contract revision and updating occurs at 20. Document verification is initiated and renewed at step 22. For example, certain documentation must be regularly renewed. The system 10 can be preprogrammed to automatically accommodate these steps by communicating directly with other contracting parties. Final evaluation occurs at step 24 and can include final acceptance by the procuring party, analysis of bonuses and penalties applicable to the contract amounts, transferring warranties and obligations, and releasing sureties is necessary. The contract can then be closed out at 26, subject to any ongoing obligations among the parties.

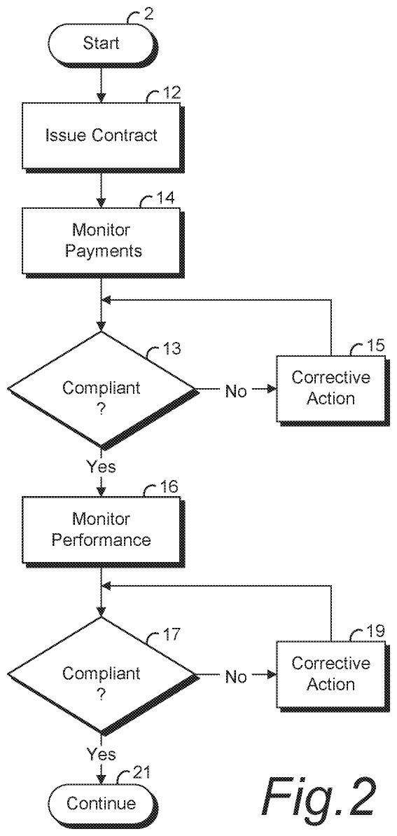

FIG. 2 shows a partial flowchart of the method, particularly emphasizing the interrelationship of the payment and performance steps with corrective action steps for noncompliant conditions. The method starts at 2 and proceeds to the issue contract and monitor payments steps 12, 14. At compliance decision box 13, the contracting procedure is tested for compliance with payment requirements. If noncompliant (“No” at compliance decision box 13) the process loops through a corrective action step at 15 and is retested for compliance at 13. If “Yes,” the process continues.

When payments are in compliance, the process proceeds to a performance monitoring step at 16. If “No,” at compliance decision box 17, the process loops through a corrective action step at 19 and is retested for compliance at 17. If “Yes,” the process continues at 21. Compliance pursuant to payment regulations and requirements can involve in-depth review of a prime contractor's payments to ensure subcontractors and vendors receive the appropriate set-asides for small businesses and other beneficiary groups. For example, project payments are susceptible to manipulation with small businesses only receiving small profit margins, even though their sales volumes on large projects are substantial. The payment and performance compliance steps can be structured to prevent such manipulations.

The system of the present invention can be configured for custom labels, which can utilize an application adapting to the vernacular of workplaces utilizing the system of the present invention. Such vernaculars often utilize different terms for the same concepts across multiple industries and businesses. Adapting such vernaculars with the present invention particularly expands the universal usefulness of the present invention. Custom fields can be utilized for organizing data sets, lists, documents, etc. The system of the present invention can utilize encryption techniques for security. For example, AES256 is a suitable industry standard for data encryption. Various other encryption standards can be utilized.

It is to be understood that the invention can be embodied in various forms, and is not to be limited to the examples discussed above. The range of components and configurations which can be utilized in the practice of the present invention is virtually unlimited.

Having thus described the invention, what is claimed as new and desired to be secured by Letters Patent is:

1. A computerized contract management, compliance monitoring and financial reporting system, which system includes:
an input subsystem configured for receiving identification and qualification data for multiple contracting parties as input data;
said input subsystem configured for receiving contractual performance data for said contracting parties as input data;
said input subsystem configured for receiving regulatory compliance data for said contracting parties as input data;
a microprocessor configured for receiving said input data from said input subsystem;
said microprocessor programmed for analyzing said input data for contract nonperformance incidents by said contracting parties; and
an output subsystem connected to said microprocessor and configured for alerting an operator of said nonperformance incidents.

2. The contract management, compliance monitoring and financial reporting system according to claim 1, which includes the additional steps of:
receiving as input diversity goals for said contracting parties;
monitoring compliance with said diversity goals by said contracting parties; and
providing output representing noncompliance with said diversity goals by said contracting parties.

3. The contract management, compliance monitoring and financial reporting system according to claim 1, which includes the additional steps of:
installing said system on an Internet, cloud-based computer system.

4. The contract management, compliance monitoring and financial reporting system according to claim 1 wherein said system is installed on an N-tier architecture system.

5. The contract management, compliance monitoring and financial reporting system according to claim 1 wherein agreement-related information is automatically tracked.

6. The contract management, compliance monitoring and financial reporting system according to claim 1, which interfaces with government-sponsored programs and contracts.

7. The contract management, compliance monitoring and financial reporting system according to claim 1, which accommodates both pre-award and post-award contracts.

8. The contract management, compliance monitoring and financial reporting system according to claim 1, which accommodates prime, subcontractor, vendor and consultant contract levels.

9. The contract management, compliance monitoring and financial reporting system according to claim 1, which tracks contract amendments, renewals, and closeouts.

10. The contract management, compliance monitoring and financial reporting system according to claim 1 including the additional steps of:
uploading document attachments for acceptance-rejection;
monitoring diversity and small business compliance issues;
managing and monitoring performance milestones, payments, retainers and payment withholdings; and
integrating with major financial systems.

11. One or more non-transitory computer-readable media storing computer-executable instructions that, when executed by a processor, perform a method of contract management, compliance verification and financial reporting, which method comprises the steps of:
storing on said computer data identifying each contracting party;
storing on said computer data representing contract performance by each said contracting party;
analyzing with said computer the performance of each contracting party relative to the terms and conditions of said contract; and
providing output from said computer representing the performance of each contracting party and its compliance with applicable regulations.
